(19) United States
(12) Patent Application Publication
(10) Pub. No.: US 2006/0089842 A1
(43) Pub. Date: Apr. 27, 2006

(54) System and method for finding, analyzing, controlling, timing and strategizing real estate investing online

(76) Inventor: Cherif R. Medawar, (US)

Correspondence Address: RUBINSTEIN LAW GROUP, PROFESSIONAL CORP;PATENTS, 100 Pine Street, 20th Floor, SAN FRANCISCO, CA, 94111, US

(21) Appl. No.: 10/971,717

(22) Filed: Oct. 22, 2004

(51) Int. Cl. G06Q 99/00

(52) U.S. Cl. 705/1

(57) ABSTRACT

The present invention teaches a computer implemented method for providing comprehensive real estate services to subscribing users via a remote computer network comprising the acts of: providing a computer network for researching real estate; receiving a plurality of property listings from a plurality of property listing sources including realtors, owners, brokers, lending institutions and state and local governments; providing user searches of the plurality of property listings; providing value analysis for the plurality of property listings in order to enable users to select undervalued and fairly valued properties, wherein the value analysis includes displaying a color indicating whether a property is overpriced; providing a service for users to purchase selected properties through the remote computer network without independently contacting agents; providing documents necessary for the purchase; providing instruction relating to the purchase; and providing financial services to enable the purchase.

### BACKGROUND OF THE INVENTION

1. Field of the Invention

The present invention relates to real estate analysis software. In particular, the present invention teaches a computer implemented method for providing comprehensive real estate services to subscribing users via the Internet.

2. Description of the Prior Art

A variety of online resources are available to help people search for real estate. Websites such as www.realtor.com and others provide potential purchasers with an endless number of places to look for real estate listings which include a fair amount of information. Once a person has located an interesting parcel of real estate, the person must then spend considerable resources in researching whether the parcel would be an advantageous purchase given the buyers current financial state, tax status and an infinite number of other factors. Once the buyer has decided to purchase the parcel he must write and present an offer/contract, locate financing, open escrow and strategize to get the highest and best use for the property. To locate a property usually locates a buyer's agent. This is often done before the buyer even begins to look at property. In most instances the buyer's agent only shows the buyer what is listed on the multiple listing services because they are usually the only properties that are listed for a commission on the sale.

The buyer's agent must contact the seller's agent. When all is done these two agents will generally take a fee equal to 6% of the purchase price. Customarily this amount comes from the sale proceeds, but there are many intangible costs to the buyer as well. Furthermore, there is countless paperwork, inspection reports, appraisals and so on associated with any real estate purchase. These can be time consuming and expensive.

In some instances a buyer's agent can direct the buyer to good sources for loans and other resources, though the buyer is at the mercy of the agent. Often time's agents will direct the buyer to relatives and friends who do not necessarily provide the best service or prices.

PRIOR ART FIG. 1 illustrates a conventional method for buying real estate using online resources at 10. A buyer 40 visits a real estate listing site 170 such as realtor.com via the Internet 120. The buyer 40 can search various residential and commercial properties within limited geographical areas on such a site, though no single site will list the great majority of properties available within a specific geographical area. Further no single site offers a comprehensive national listing of properties offered for sale. If a buyer 40 is looking for under valued property he may try a site such as foreclosures.com, though this introduces a large element of risk. Buyer 40 may even search for properties listed for sale by owners available on sites such as owners.com.

Once the buyer has located a property he is interested in, the buyer 40 generally must then locate a buyer's agent. Occasionally such agents can be contacted through a realtor site 170, but may have to be located through other means. The buyer's agent must then contact the seller's agent, who may or may not be available on the Internet 120. The buyer must also locate a mortgage lender 50. Though many lenders are located on the Internet, communication between a lender and the seller's and buyer's agents can be complex and burdensome for all parties. Additionally the buyer will need title insurance, inspections, home owners insurance, and may need an attorney or other specialist to examine disclosure documents, finance documents or any number of other devices. Furthermore the fees involved with dealing with these many persons, entities and agents can be very large.

As the above discussion reflects, no prior art resources provide an easy to understand and efficient method for finding, analyzing, controlling, timing and strategizing a real property purchase. Furthermore, no prior art service can access listings of properties for sale anywhere in the United States under one location covering what is listed for sale by realtors, by owners, and in foreclosures, whether residential or commercial.

No existing technology allows a prospective buyer with an easy to understand color coded scheme for analyzing and determining whether or not a property is a good value within a specific location, within a specific period of time.

Furthermore, no existing service providers offer the capability to control the purchase through the use of a state approved contract with all the proper, required documents for inspections and disclosures. No existing service providers offer flexible and powerful financing even to buyers who have low or no credit. No existing service providers offer the capability to strategize to discover the highest and best use for each property. No existing service providers offer to analyze and manage currently owned properties. Additionally, no existing service providers offer detailed analysis of property through specific markets. Further, no services exist to provide comprehensive service for all phases of locating, purchasing and insuring real estate. Lastly no one offers a mortgage put, which insures a purchase of real property against depreciation like an option on a stock or commodity.

What is needed is an easy to understand and efficient method for finding, analyzing, controlling, timing and strategizing the purchase of real property. Furthermore needed is a service that can access listings of properties for sale by different type of seller's such as realtors, private owners and foreclosures both in the residential and commercial markets anywhere in the United States.

Additionally needed a real estate research service for a prospective buyer with an easy to understand color coded scheme for determining whether or not a property is a good value within a specific location, within a specific period of time. What is also needed is a service provider offering the state approved contract, inspection documents, and necessary disclosure to legally control the purchase.

What is also needed is a service provider offering fast and flexible financing even to buyers with low or no credit scores.

What is also needed is a service to strategize with the buyer to identify the highest and best use of the property.

What is also needed is a service to provide comprehensive service for all phases of locating, purchasing and insuring real estate.

Finally what is needed is a system that offers a mortgage put, which insures a purchase of real property against depreciation like an option on a stock or commodity.

### SUMMARY

The present invention provides an easy to understand and efficient method for finding, researching, analyzing, controlling, timing and strategizing the purchase of real property. Also provided is a real estate research service for a prospective buyer with an easy to understand color coded scheme for determining whether or not a property is a good value. Additionally provided is a service that can access listings of properties for sale anywhere in the United States.

Also taught is a service provider offering the capability to analyze and manage currently owned properties.

Also taught is a service provider offering detailed analysis of property through specific markets.

Also taught is a service to provide comprehensive service for all phases of locating, purchasing and insuring real estate.

Finally what is taught is a system that offers a mortgage put, which insures a purchase of real property against depreciation with a function similar to an option on a stock or commodity.

A first embodiment of the present invention teaches a computer implemented method for providing comprehensive real estate services to subscribing users comprising the acts of: providing a computer network for determining real estate value; providing to the computer network data relating to real estate value; determining relative value of a selected property responsive to sales prices of similarly situated property; determining asking price for the selected property; comparing the relative value of the selected property to the asking price of the selected property; and displaying a purchase value indicator of the comparison to a user such that the user can determine whether a property is priced above or below the relative value. In accordance with one embodiment the purchase value indicator is color coded to indicate whether the selected property is priced above or below the relative value. In accordance with another embodiment the purchase value indicator includes a directional element indicative of whether the asking price of the selected property is above or below the relative value of the selected property.

In accordance with yet another embodiment the color coding includes a gradation to indicate a relative level of a difference between the relative value and the asking price.

In accordance with an alternative embodiment of the present invention the data includes sale prices for a plurality of properties in various geographic areas, and wherein the data further includes other data for the plurality of properties, the other data including at least one of the following elements for each of the plurality of properties: comparable square footage; comparable number of bedrooms, comparable number of baths; comparable number of floors, comparable age of structure

A second embodiment of the present invention further teaches determining the relative value responsive to a specific geographic location for the selected property, wherein the relative value is determined by comparing valuation data for the selected value with valuation data for other properties with similar geographic valuation factors, wherein the geographic valuation factors include demographic information relating to the plurality of other properties. In accordance with such an embodiment a green color indicates that the selected property is priced below the relative value and wherein a red color indicates that the selected property is priced above the relative value.

Also taught is a method further comprising providing a map display in which relative values are differentiated by colors indicating relative values of real estate offered for sale by geography, wherein undervalued property is colored differently than over valued property. In accordance with another embodiment the geographic valuation factors are provided by a third party computer network.

Further taught is a system providing property listing services for property owners and agents. Yet further provided is a value analysis system for a plurality of property listings in order to enable users to select undervalued and fairly valued properties, wherein the value analysis includes displaying a color indicating whether a property is overpriced, and further includes providing analysis of market trends in property value. Further taught is providing property management services for analyzing cash flow of rental properties, wherein the property management services are further capable of providing analysis of financial consequences of rental transactions and condominium conversions relating to the rental properties, including tax consequences.

In accordance with one embodiment the present invention teaches compiling a list of multiple properties meeting selected search criteria, wherein each property includes an asking price; determining a market value for each property using third party computer data services; comparing each market value with each asking price to determine relative purchase value; displaying the list of multiple properties with color coding indicating which properties are undervalued. Also taught is providing financial analysis for the selected property including property tax information, loan information, and income tax deduction analysis.

In accordance with one embodiment of the present invention is taught a method for providing services for purchasing the selected property online including step by step instructions for the purchasing process; providing financing for the purchase; providing documentation necessary for the purchase; providing insurance for the selected property; providing inspection services for the selected property; providing title services relating to the selected property; and providing escrow services for the purchase.

In accordance with one embodiment is further taught: providing purchase services for acquiring the selected property; and providing insurance service which provides a safeguard against the acquired property dropping in value, thus reducing the risk associated with purchasing real property.

In accordance with another preferred embodiment is taught a computer implemented method for providing comprehensive real estate services to subscribing users via a remote computer network comprising the acts of: providing a computer network for researching real estate; providing to the computer network data relating to real estate value; receiving from a client property search parameter range; performing a property search in response to the search parameter range; retrieving one or more properties conforming to the search parameter range; retrieving asking prices for each of the one or more properties conforming to the search parameter range; determining a market value of an ideal property for each of one or more properties conforming to the search parameter range; comparing each the market value to each corresponding asking price to determine differences in market values and asking prices; and providing a color coded listing of each the one or more properties conforming to the search parameters, wherein the color coding indicates whether purchase of the one or more properties is recommended.

In accordance with yet another alternative embodiment of the present invention is taught a computer method for providing comprehensive real estate services to subscribing users via a remote computer network comprising the acts of: providing a computer network for researching real estate; receiving a plurality of property listings from a plurality of property listing sources including realtors, owners, brokers, lending institutions and state and local governments; providing user searches of the plurality of property listings; providing value analysis for the plurality of property listings in order to enable users to select undervalued and fairly valued properties, wherein the value analysis includes displaying a color indicating whether a property is overpriced; providing a service for users to purchase selected properties through the remote computer network without independently contacting agents; providing documents necessary for the purchase; providing instruction relating to the purchase; and providing financial services to enable the purchase.

In accordance with other embodiments of the present invention proprietary methods for listing and selling real estate are used to enable subscribers/sellers to cash out their equity immediately.

In accordance with other embodiments of the present invention proprietary methods for representing subscribers/buyers and assisting them in purchasing real estate are used to assist them in qualifying for loans and obtaining favorable terms.

In accordance with other embodiments of the present invention proprietary methods for valuing income producing properties and land developments as well as rehabs, are used to enable subscribers to make a clear decision on whether the property transaction would be profitable.

In accordance with other embodiments of the present invention proprietary methods for acquiring a loan to purchase a property below market value are used to enable a subscriber to benefit from the instant equity that exists when finding a good deal below market price.

### BRIEF DESCRIPTION OF THE DRAWINGS

PRIOR ART FIG. 1 is a functional block diagram illustrating a conventional method for buying real estate using online resources in accordance with the prior art;

FIG. 2 illustrates by block diagram a system for efficiently finding, analyzing and controlling real estate transactions in accordance with one embodiment of the present invention;

FIG. 3 is a simplified flow chart diagram illustrating a method for searching for real estate in accordance with one embodiment of the present invention;

FIG. 4 is a simplified flow chart diagram illustrating a process for purchasing real property using the Real Estate FACTS service in accordance with one embodiment of the present invention;

FIG. 5 is a simplified flow chart diagram illustrating a process for selling property using the Real Estate FACTS website in accordance with one embodiment of the present invention;

FIG. 6 is a simplified flow chart diagram illustrating a website process for analyzing real estate decisions in accordance with one embodiment of the present invention;

FIG. 7 is a pictoral diagram of a sample display form for enabling subscribers to quickly and accurately choose properties of interest in accordance with a preferred embodiment of the present invention;

FIG. 8 is a pictoral diagram showing a customized comparable screen in accordance with one embodiment of the present invention;

FIG. 9 is a pictoral diagram illustrating a more detailed value analysis screen resulting from the selection of two properties in FIG. 8 in accordance with one embodiment of the present invention; and

FIG. 10 is a pictoral diagram illustrating a customizable search result screen at 900 in accordance with a preferred embodiment of the present invention.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for an easy to understand and efficient method for finding, researching, analyzing and purchasing real property. Also taught is a real estate research service for a prospective buyer with an easy to understand color coded scheme for determining whether or not a property is a good value. Additionally taught is a service that can access listings of properties for sale anywhere in the United States.

Also taught is a service provider offering the capability to analyze and manage currently owned properties.

Also taught is a service provider offering detailed analysis of property through specific markets.

Also taught is a service to provide comprehensive service for all phases of locating, purchasing and insuring real estate.

Finally what is taught is a system that offers a mortgage put, which insures a purchase of real property against depreciation like an option on a stock or commodity.

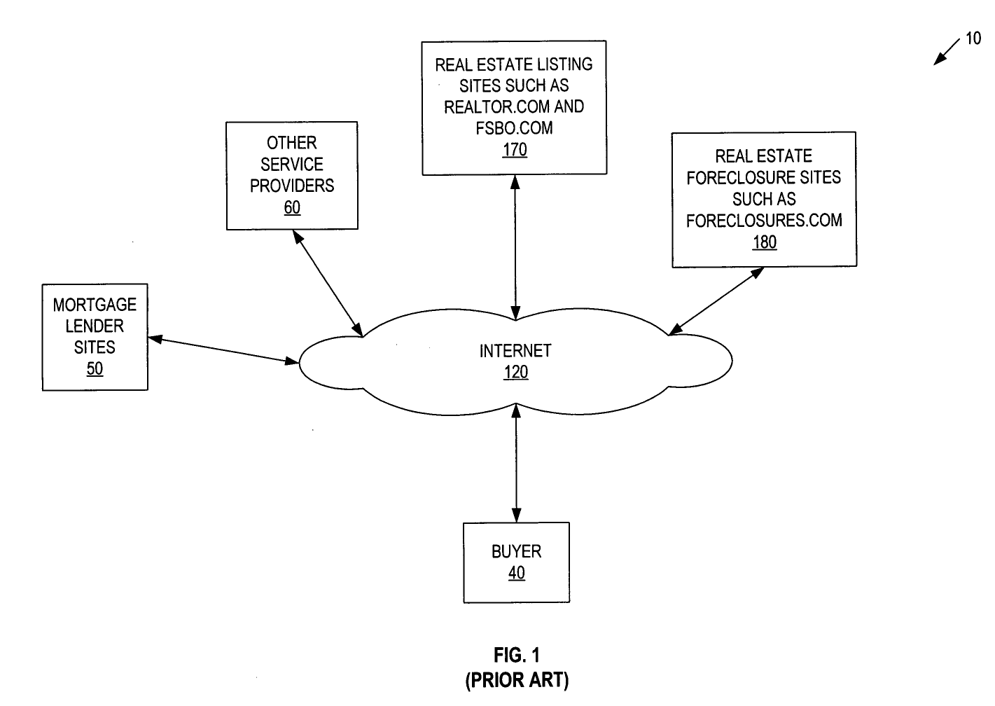

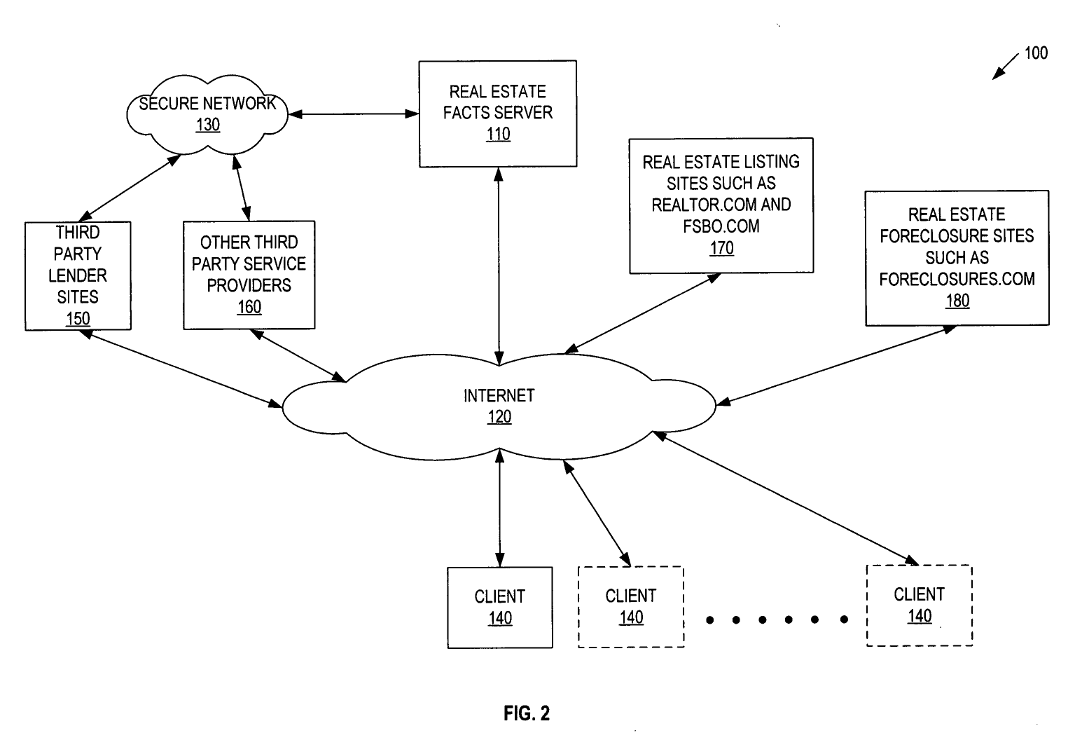

FIG. 2 illustrates the architecture for a system for efficiently finding, analyzing and controlling real estate transactions at 100 in accordance with one embodiment of the present invention. A client 140 may access the Real Estate FACTS (Find Analyze Control Time Strategize) server 110 via a secure Internet connection 120 to take care of any needs associated with the purchasing or selling of real estate. Generally clients will be provided access to the FACTS server 110 for a monthly fee, though other service arrangements may also be possible. The FACTS server 110 compiles comprehensive lists of available real estate by accessing numerous third party websites 170, 180 such as www.realtor.com, www.FSBO.com, www.foreclosures.com, www.loopnet.com and others. Server 110 will also have access to nation wide “for sale by owner” sites such as www.warnock.com. This will allow clients 140 access to virtually any property for sale in the U.S. including HUD, NOD, probate and other hard to locate property. This allows the FACTS server 110 to provide customized property searches for any location or region within the United States, and allows clients 140 to find virtually any purchase opportunity within the U.S.

Once a client has selected a property, or properties of interest, the FACTS server 110 can perform a value analysis on the selected property. This analysis can be performed within the FACTS server system 110, or may be shopped out or generating using third party service providers 160 such as www.dataquick.com. By using such notable third party resources the system of the present invention can cheaply and efficiently provide up to date and accurate analysis. Further tools provided will include an analysis of cyclic patterns and trend recognition in real estate markets throughout the country for any selected type of property.

Once a client has done sufficient research to make a buying decision the client 140 can acquire financing from third party lenders 150 allied with Real Estate FACTS 110. The FACTS server 110 will provide all necessary forms and communication with lending sites 150, either via the Internet 120 or preferably using a secure network 130 to minimize security risks to buyers. Once a buyer is approved for purchase, the FACTS server 110 will arrange communication with the property sellers agent enabling the buyer to secure the desired property under contract. Once again all necessary documents and services are provided by the FACTS server 110 or by other third party service providers 160 partnered with Real Estate FACTS. The FACTS server can also provide downloadable forms from local government sites and information on local laws and real estate customs. The function of the FACTS server 110 is to eliminate or minimize actions taken to perform real estate research and real estate transactions. For many clients 140 it will be possible to purchase a property without using any resources outside of those provided by the www.realestatefacts.com website.

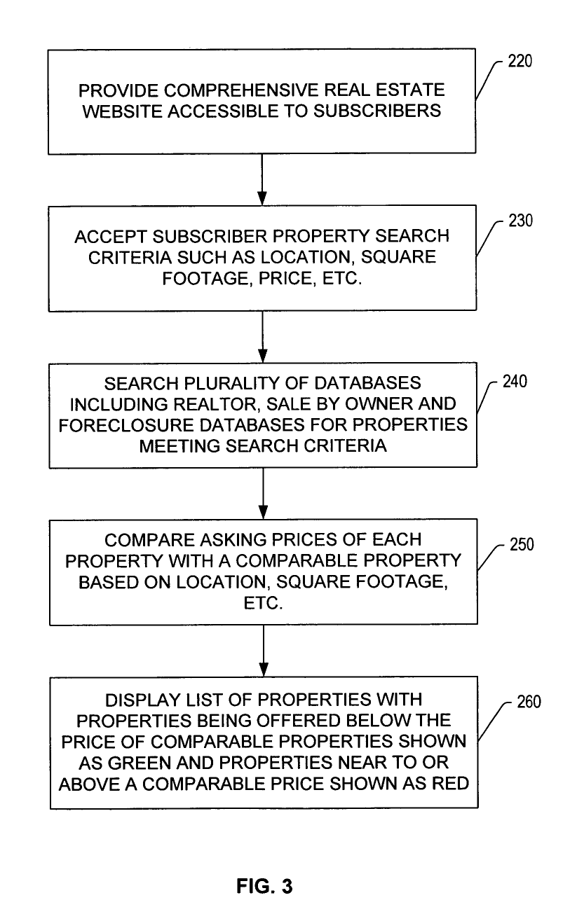

FIG. 3 illustrates a method for searching for real estate in accordance with one embodiment of the present invention. At a step 220 a comprehensive real estate website is provided to subscribers for a monthly fee. At a step 230 a subscriber is prompted for property search criteria such as location, minimum square footage and maximum price. Other search criteria may also be used such as number of beds/baths, demographic statistics such as average income, age, crime, education, etc. At step 240 the website searches a plurality of websites and other resources listing property in the relevant geographical region or regions. These databases may contain information on properties being offered for sale by owners, realtors, lenders, governments or other entities.

In a step 250 the FACTS website compares the asking prices of each property located with a comparable property. Such a comparison may simply compare price, or may account for factors such as square footage, specific neighborhood, school zone, number of bedrooms and baths, etc. Finally in a step 260 properties are displayed with properties being offered below the price of comparable properties being shown in green and properties offered near to or above the price of comparable properties being shown in red. This allows a subscriber to quickly see which properties are a good “deal” and which are not. In some cases prices may be misleading, but the website will take into account as many factors in determining market value as is feasible.

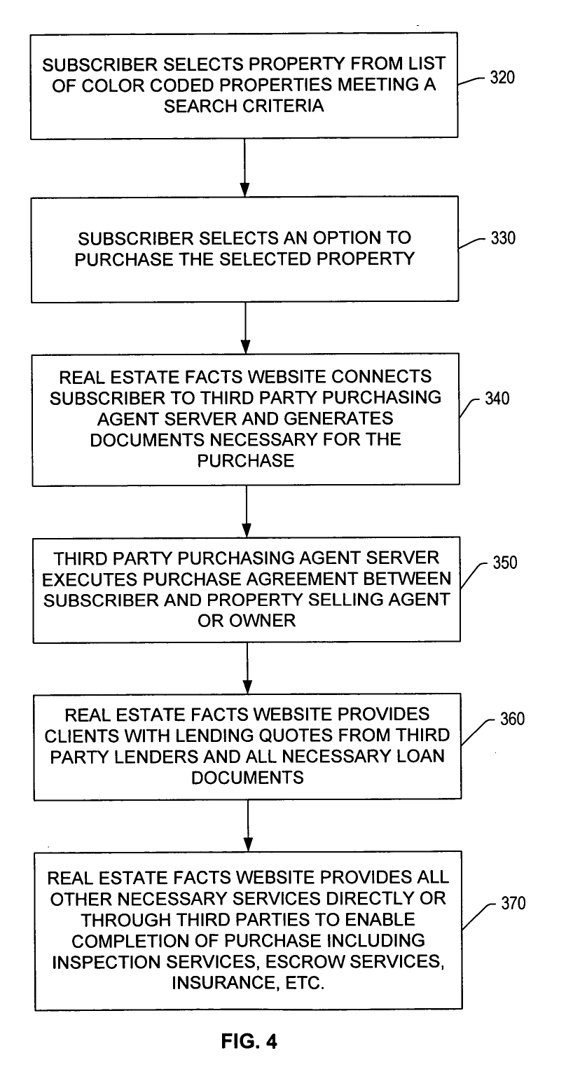

FIG. 4 shows a process for purchasing real property using the Real Estate FACTS service in accordance with one embodiment of the present invention. At a step 320 a FACTS subscriber selects property form a list of property which is color coded to show which properties are priced below estimated market value. The subscriber selects a menu option to purchase the selected property at a step 330. Then at a step 340 the Real Estate FACTS website contacts a third party purchasing agent site and generates documents necessary for the purchase. In a step 350 the third party purchasing agent executes a purchase agreement between the seller or sellers agent and the subscriber securing the property. In a step 360 the FACTS site provides the subscriber with quotes for financing the transaction from third party lenders and provides all necessary loan documents. In step 370 all other necessary services are provided to enable completion of the purchase including inspection services, title searches, title insurance, mortgage insurance, appraisal services and escrow services. These services may be supplied directly or through third party providers in partnership with the Real Estate FACTS service.

In accordance with one embodiment a loan is pre-approved through online lenders before contact is made with buyers or sellers agents. Further, the services of a buyers agent may be provided directly by Real Estate FACTS instead of a third party agent. In accordance with one embodiment of the present invention lender and purchase forms are provided online, but the subscriber will have to deliver such forms to the appropriate parties or agencies.

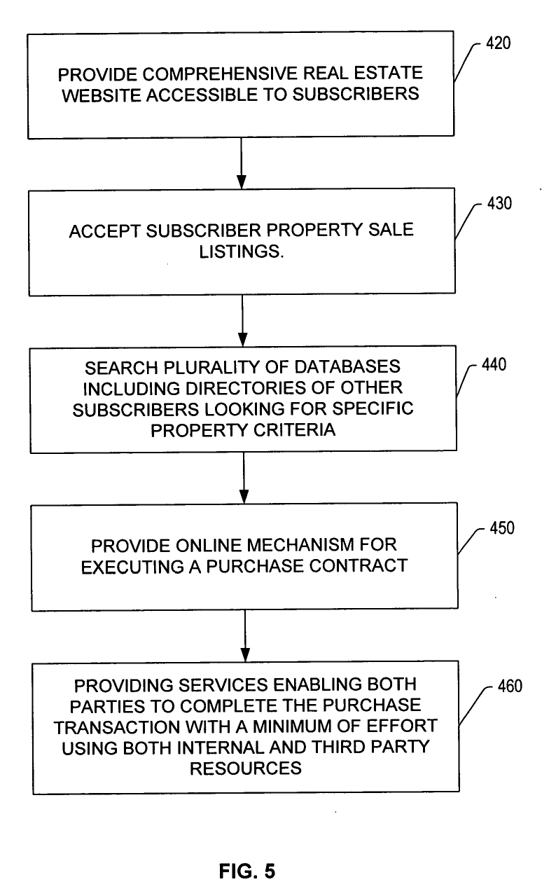

FIG. 5 shows a process for selling property using the Real Estate FACTS website in accordance with one embodiment of the present invention. The process begins at step 420, in which a subscriber accesses the comprehensive real estate services website. In a step 430 the subscriber enters all information relevant for the sale of the property into the website listing service. In step 440 multiple databases listing buyers potentially interested in purchasing the property whose needs meet criteria met by the information entered by the seller. These databases may include listings of other subscribers who are interested in real estate speculation as well as third party databases. All buyers with criteria matching the characteristics of the property are displayed to the seller. The seller may then select a desired buyer. In accordance with one embodiment of the present invention some buyers may have pre-approval status in which case the website will automatically purchase any property meeting a certain criteria. If such a buyer is displayed the seller may simply choose an option to execute a sales transaction with the buyer. In a step 450 a mechanism for executing a sales agreement with the selected buyer is accessed. In step 460 all services necessary for enabling both parties to complete the purchase transaction with a minimum of cost or effort are provided by the Real Estate FACTS server 110 (FIG. 2) using both internal and third party resources. In some cases this may be performed with little or no human interaction, though in most cases buyers will need to be contacted to determine whether an agreement can be reached. In either case documentation and services can be provided via the website 110 (FIG. 2).

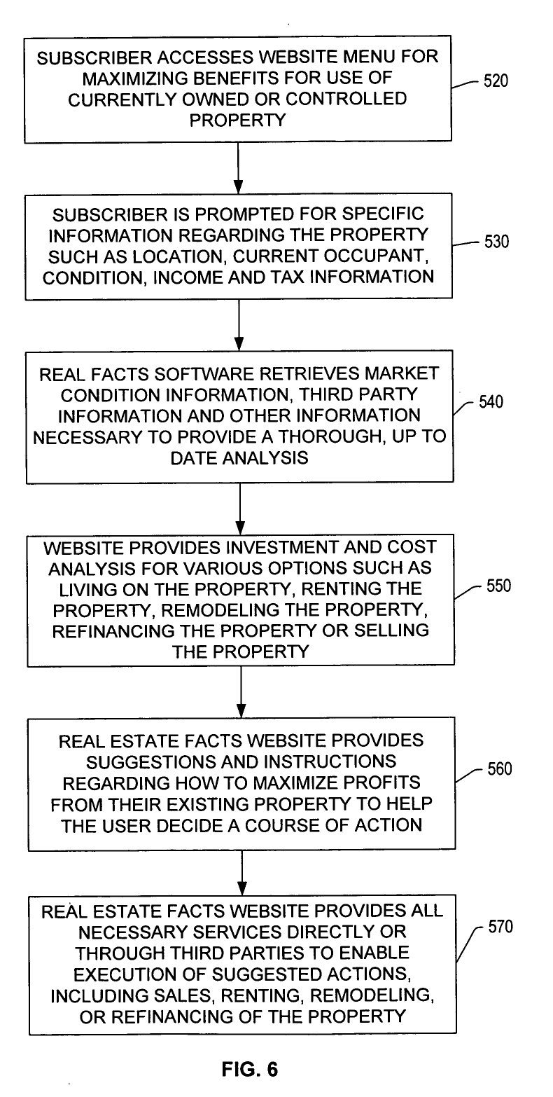

FIG. 6 shows a website process for analyzing real estate decisions in accordance with one embodiment of the present invention. The process begins at step 520, in which a user accesses the FACTS website seeking to maximize financial gains for currently owned real estate. In a step 530 the subscriber is prompted for specific information regarding the property such as location, current occupants, physical condition, income and tax information. Other information required may specifically include the subscribers income, residency, income history, tax history, and employment history, and may further include characteristics of the property and its current and past use.

In step 540 the Real Estate FACTS software retrieves current market condition information, third party information and any other information necessary to provide a thorough, up to date analysis of the actions available to the property owner/manager. This is generally accomplished using both in-house software and third party services, and may include human analysis by in-house or third party specialists. Most of the economic statistics will be gathered from third party financial websites and will be gathered by automated systems. In step 550 the website 110 (FIG. 2) provides investment and cost analysis for various options such as owner occupation of the property, renting the property, remodeling the property, refinancing the property, or divesting some or all of the property in question. The options may automatically be narrowed to eliminate options resulting in a certain threshold of unacceptable losses or costs. In accordance with a preferred embodiment the analysis will be performed automatically by software located on the server and by third party services. In some cases human analysis may be appropriate. A menu will allow the subscriber to view each option in great detail in order to help the subscriber make the best decision. Further, educational links will be available to take the subscriber through step by step processes for executing any selected action, as well as to explain the ramifications of any of the subscribers potential options.

In step 560 the Real Estate FACTS website provides suggested courses of actions including instructions regarding how to best maximize profits from the existing property. Also provided will be extensive educational support to fully educate the subscriber in all aspects of the suggested courses of action. In accordance with one embodiment a 1-900 help line will be available for a premium fee, or on a price per minute basis. In a step 570 the Real Estate FACTS website provides all necessary services directly or through third parties to enable execution of suggested courses of actions, including sales, rental, remodeling, or refinancing of the property or properties in question.

In accordance with other embodiments of the present invention proprietary methods of identifying market trends and cyclic patterns are used to enable subscribers to make the most informed buying, selling and/or other decisions regarding real estate. Such proprietary methods would utilize varied algorithms incorporating a large array of variables to maximize potential profits.

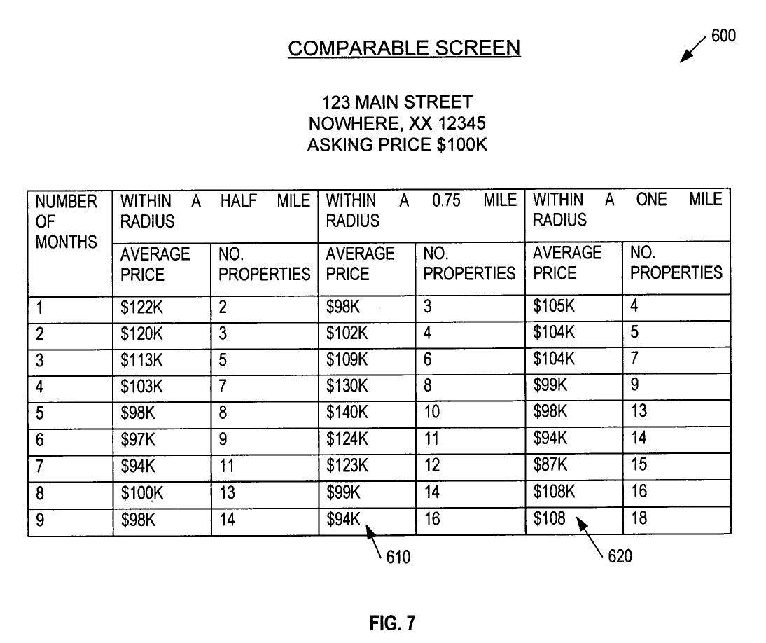

FIG. 7 shows a sample display form for enabling subscribers to quickly and accurately choose properties of interest in accordance with a preferred embodiment of the present invention. This “Comparable Screen” 600 shows a selected property 610 with an asking price of $100,000. The customizable table 600 shows a history of properties sold within various distances of the selected property 610 and their selling prices.

In accordance with a preferred embodiment of the present invention average selling prices exceeding the asking price of the selected property 610 are shown as green. For example the box 620 would be colored in as green to indicate that the $108,000 average price for houses in that radius and that month was above the asking price of the selected property 610. Conversely, box 630 would be colored in as red to indicate that the average selling price for that month and radius of $94,000 was less than the current asking price of the selected property 610. This allows users to quickly see whether the history of property sales near the selected property support the asking price of the property. If most of the screen is colored green then the asking price for the selected property is likely to be below market value.

In accordance with a preferred embodiment the table 600 is customizable for both periods of time and geographical values. In accordance with one embodiment additional factors can be displayed such as square footage, number of bedrooms, number of bathrooms, existence of a swimming pool, sauna, fireplaces, age of properties and number of floors.

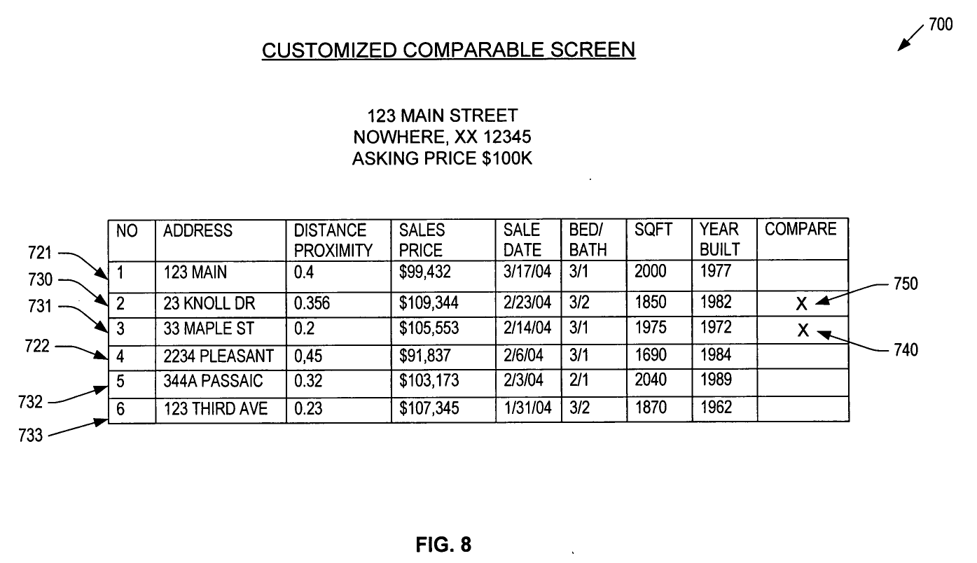

FIG. 8 shows a customized comparable screen 700 in accordance with one embodiment of the present invention. In this embodiment the selected property 710 is compared to other properties selling within half of a mile within the last 6 months. Properties that sold below the asking price are colored red to indicate that the selected property may be overpriced. Conversely, properties that sold above the selected property 710 asking price are shown as green to indicate that the selected property 710 may be under priced, and may be a good “deal”. In the present example lines 721 and 722 are colored red while lines 730, 731, 732 and 733 are colored green. This shows mixed signals regarding whether the property is being offered above or below an appropriate market value. If all of the lines where colored green then it would be more likely that the property is under priced.

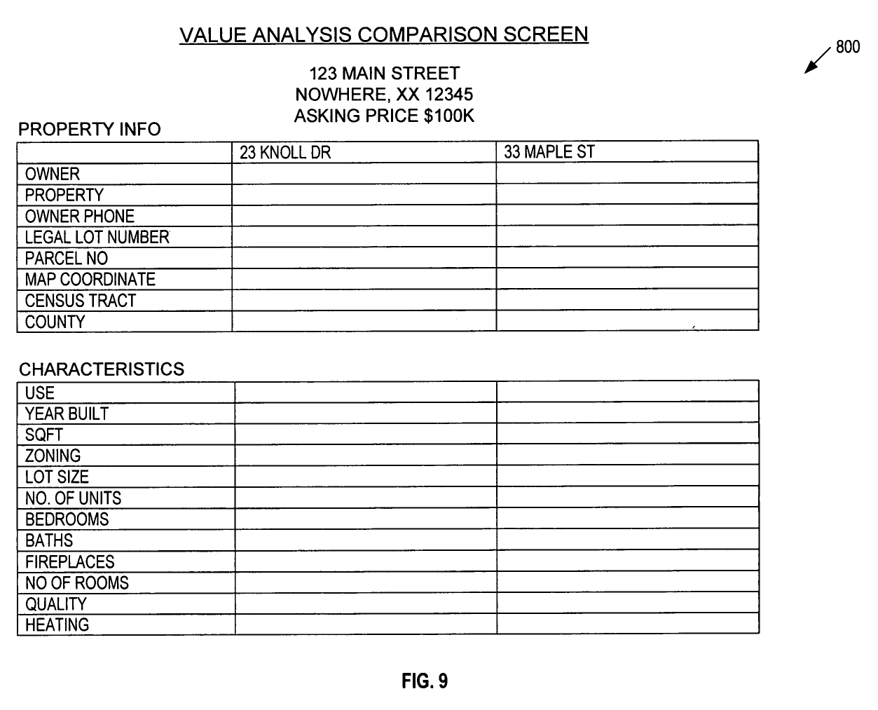

The main advantages of this screen 700 over screen 600 (FIG. 7) are that more detail for each property is shown and a direct comparison option 740 is available. In the present embodiment the user has selected properties to directly compare by checking boxes 750 and 760. These properties will be more closely examined in screen 800 (FIG. 9).

FIG. 9 shows a more detailed value analysis screen 800 resulting from the selection of two properties in FIG. 8 in accordance with one embodiment of the present invention. The two properties are compared side by side such that each of their characteristics can be compared at a glance. This enables a buyer to quickly determine whether there are reasons for seeming anomalies in pricing, or whether the prices are fairly compared to a house he wishes to purchase. The net effect of such a tool is to enable a potential buyer to make a more informed decision regarding the current fair market price of a property he or she is interested in. For example, if properties 721 (FIG. 8) and 722 (FIG. 8) had significant problems such as poor condition, or issues relating to age, zoning, etc. then a buyer could be justified in discounting their otherwise negative effect on his buying decision.

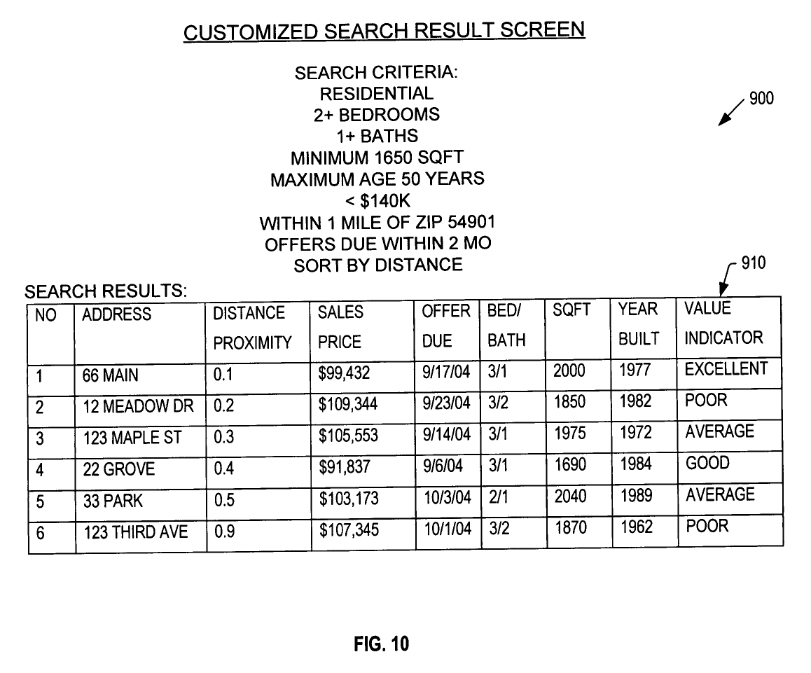

FIG. 10 shows a customizable search result screen at 900 in accordance with a preferred embodiment of the present invention. In accordance with a preferred embodiment a subscriber can enter search criteria and search for properties meeting individual needs in any region within the U.S.

Search result screen 900 shows a search for property within 1 mile of the center of zip code 54901, having minimum requirements for square footage, number of bedrooms, age, etc. Value indicator column 910 indicates how each property compares to selling prices of similarly situated properties in the past. The algorithm used to determine relative value will take into account many factors including square footage, age, condition, zoning, demographics and others compared to historical sales data. In addition to giving value rankings such as good, excellent, poor etc. rows of the table may be color coded with excellent rated properties being displayed as bright green, good rated properties as dark green and poor rated properties as red. Other schemes may also be used to make selecting properties for further investigation as quick and easy as possible. In accordance with a preferred embodiment of the present invention properties below a comparable market value are colored green and properties near or above the comparable market value are colored red.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A computer implemented method for providing comprehensive real estate services to subscribing users comprising the acts of:
providing a computer network for determining real estate value;
providing to the computer network data relating to real estate value;
determining relative value of a selected property responsive to sales prices of similarly situated property;
determining asking price for the selected property;
comparing the relative value of the selected property to the asking price of the selected property; and
displaying a purchase value indicator of the comparison to a user such that the user can determine whether a property is priced above or below the relative value.

2. A method as recited in claim 1, wherein the purchase value indicator is color coded to indicate whether the selected property is priced above or below the relative value.

3. A method as recited in claim 1, wherein the purchase value indicator includes a directional element indicative of whether the asking price of the selected property is above or below the relative value of the selected property.

4. A method as recited in claim 2, wherein the color coding includes a gradation to indicate a relative level of a difference between the relative value and the asking price.

5. A method as recited in claim 1, wherein the data includes at least one of the following elements: square footage; number of bedrooms; number of baths; number of floors; age of structure, and wherein the relative value is responsive to at least one of the elements.

6. A method as recited in claim 5, wherein the data includes sale prices for a plurality of properties in various geographic areas, and wherein the data further includes other data for the plurality of properties, the other data including at least one of the following elements for each of the plurality of properties: comparable square footage; comparable number of bedrooms, comparable number of baths; comparable number of floors, comparable age of structure.

7. A method as recited in claim 6 further comprising:
determining the relative value responsive to a specific geographic location for the selected property, wherein the relative value is determined by comparing valuation data for the selected value with valuation data for other properties with similar geographic valuation factors.

8. A method as recited in claim 7 wherein the geographic valuation factors include demographic information relating to the plurality of other properties.

9. A method as recited in claim 7, further comprising providing a map display in which relative values are differentiated by colors indicating relative values of real estate offered for sale by geography, wherein undervalued property is colored differently than over valued property.

10. A method as recited in claim 7, wherein the geographic valuation factors are provided by a third party computer network.

11. A method as recited-in claim 2, wherein a green color indicates that the selected property is priced below the relative value and wherein a red color indicates that the selected property is priced above the relative value.

12. A method as recited in claim 1, further comprising providing property listing services for property owners and agents.

13. A method as recited in claim 1, further providing value analysis for a plurality of property listings in order to enable users to select undervalued and fairly valued properties, wherein the value analysis includes displaying a color indicating whether a property is overpriced, and further includes providing analysis of market trends in property value.

14. A method as recited in claim 1, further comprising:
providing property management services for analyzing cash flow of rental properties, wherein the property management services are further capable of providing analysis of financial consequences of rental transactions and condominium conversions relating to the rental properties, including tax consequences.

15. The computer implemented method of claim 1, further comprising:
compiling a list of multiple properties meeting selected search criteria, wherein each property includes an asking price;
determining a market value for each property using third party computer data services;
comparing each market value with each asking price to determine relative purchase value;
displaying the list of multiple properties with color coding indicating which properties are undervalued.

16. The computer implemented method of claim 1, further comprising:
providing financial analysis for the selected property including property tax information, loan information, and income tax deduction analysis.

17. The method of claim 1, including;
providing services for purchasing the selected property online including step by step instructions for the purchasing process;
providing financing for the purchase;
providing documentation necessary for the purchase;
providing insurance for the selected property;
providing inspection services for the selected property;
providing title services relating to the selected property; and
providing escrow services for the purchase.

18. The computer implemented method of claim 1, further including the acts of:
providing purchase services for acquiring the selected property; and
providing insurance service which provides a safeguard against the acquired property dropping in value, thus reducing the risk associated with purchasing real property.

19. A computer implemented method for providing comprehensive real estate services to subscribing users via a remote computer network comprising the acts of:
providing a computer network for researching real estate;
providing to the computer network data relating to real estate value;
receiving from a client property search parameter range;
performing a property search in response to the search parameter range;
retrieving one or more properties conforming to the search parameter range;
retrieving asking prices for each of the one or more properties conforming to the search parameter range;
determining a market value of an ideal property for each of one or more properties conforming to the search parameter range;
comparing each the market value to each corresponding asking price to determine differences in market values and asking prices; and
providing a color coded listing of each the one or more properties conforming to the search parameters, wherein the color coding indicates whether purchase of the one or more properties is recommended.

20. A computer method for providing comprehensive real estate services to subscribing users via a remote computer network comprising the acts of:
providing a computer network for researching real estate;
receiving a plurality of property listings from a plurality of property listing sources including realtors, owners, brokers, lending institutions and state and local governments;
providing user searches of the plurality of property listings;
providing value analysis for the plurality of property listings in order to enable users to select undervalued and fairly valued properties, wherein the value analysis includes displaying a color indicating whether a property is overpriced;
providing a service for users to purchase selected properties through the remote computer network without independently contacting agents;
providing documents necessary for the purchase;
providing instruction relating to the purchase; and
providing financial services to enable the purchase.
